(19) United States
(12) Patent Application Publication
(10) Pub. No.: US 2021/0331747 A1
(43) Pub. Date: Oct. 28, 2021

(54) Structural Component

(71) Applicant: Weber Fibertech GmbH, Markdorf (DE)

(72) Inventor: Norbert STÖTZNER, Markdorf (DE)

(21) Appl. No.: 17/235,173

(22) Filed: Apr. 20, 2021

(30) Foreign Application Priority Data
Apr. 23, 2020 (DE) 202020102252.0

(51) Int. Cl. B62D 25/20; B60W 50/02

(52) U.S. Cl. CPC B62D 25/2072; B60W 2420/406; B60W 2420/22; B60W 50/02

(57) ABSTRACT

Structural component, in particular for a vehicle body, comprising a structural element (12) and a sensor arrangement (16), wherein the sensor arrangement (16) is connected to the structural element (12) and comprises at least one optical waveguide (14).

The invention relates to a structural component, in particular a structural component for a motor vehicle.

Structural components are used in many fields and regularly serve to absorb and transmit mechanical forces. They can also serve to connect other components to one another. In many cases, attempts are made to provide a structural component with high rigidity and at the same time low weight. This is particularly important in the field of lightweight construction, which is increasingly proving to be advantageous and is being used more and more frequently in many technical fields.

Vehicles, in particular motor vehicles, can also be designed to be lighter and more stable by using such structural components without having to forego comfort and safety.

In the vehicle sector, the use of structural components helps, among other things, to reduce CO₂ emissions. Structural parts are used in this field to protect components and assemblies. Flat, fiber-reinforced structural components can be used on the underside of a vehicle, for example, and then serve as underbody protection.

DE 10 2017 110 906 A1 describes a structural component that is configured in particular for use in a vehicle body. The structural component has a first structural element which at least partially surrounds a spatial region, so that a cavity is formed in the interior of the first structural element. This first structural element has a surface region delimiting this cavity and a second structural element. A reinforcement element is also provided which serves to mechanically reinforce the first structural element.

It should be noted that structural components are designed for specific load cases and can withstand these load cases. In operation, however, load cases can occur that can only be mastered by components, but their use has disadvantages such as high weight, large installation space, and/or expensive materials.

Against this background, a structural component having the features of claim 1 is presented. Embodiments emerge from the dependent claims and from the description.

It has now been recognized that, as an alternative to the use of structural components with the disadvantages mentioned, it is possible to use structural components that can be made more cost-effective, lighter, and/or slimmer if the structural component is designed in such a way that damage thereto can be recognized reliably.

The loads applied to the structural component from the outside can also be very low, so that the structural component only has to support itself. In this case, the structural component represents a sensor plate.

It was also recognized that a suitable or corresponding sensor system can be used to detect damage of this type to the structural component, which is configured to detect damage of this type. This means that if the structural component is damaged due to excessive loading, the sensor system detects this damage. This damage can then, for example, be displayed to the user or the driver or to another person, so that the damaged structural component can then be replaced if necessary.

Vibroacoustic sensors, strain gauges, and comparable sensors come into consideration as possible sensors or sensor systems. Herein, the following is proposed:

A structural component which is intended in particular for a vehicle body. This structural component comprises a structural element and a sensor arrangement, the sensor arrangement being connected to the structural element. Furthermore, the sensor arrangement comprises at least one optical waveguide.

The structural element represents the body which, in the installed state, serves, for example, to absorb and transmit mechanical forces and/or to connect other components to one another. The sensor arrangement and thus the at least one optical waveguide are connected to this structural element.

Optical waveguides are cables and lines consisting of light guides that serve for the transmission of light. It should be noted that these do not only serve for the transmission of light in the visible range, but can also transmit electromagnetic waves outside the visible range. For example, light in the infrared or ultraviolet range can also be transmitted. The sensor arrangement of the proposed structural component is therefore not limited to the visible wavelength range.

In many cases, optical waveguides are also referred to as glass fiber cables, a plurality of optical waveguides typically being bundled therein, which are also mechanically reinforced for the protection and stability of the individual fibers. In any case, the structural component described is not limited to glass fibers as optical waveguides.

The optical waveguides used can also be at least partially provided with suitable plug connectors.

The at least one optical waveguide is connected to the structural element in such a way that an impairment of the function of the at least one optical waveguide takes place in the case of excessive stress of the structural element or in the case of damage thereto. At one end of the optical waveguide, light or electromagnetic radiation is typically fed in with a light-emitting element and decoupled at the other end and detected with a corresponding photosensitive or light-sensitive element.

The impairment of the function of the at least one optical waveguide can thus be recognized and a conclusion can be drawn about excessive loading or even damage to the structural element. In this way, damage or impending damage to the structural element and thus also to the structural component can preferably be detected in good time, and suitable countermeasures can be initiated. For example, a defective structural component can be replaced.

In one embodiment, at least one optical waveguide of the at least one optical waveguide is arranged in the structural element. The at least one optical waveguide thus runs in the structural element or in the interior of the structural element. Such a structural component can be manufactured, for example, by insert molding or casting around the material of the structural element around the at least one optical waveguide. Another method provides for at least one hole to be made in the manufactured structural element, through which at least one optical waveguide is then guided. In a further embodiment, at least one optical waveguide of the at least one optical waveguide is arranged on a surface of the structural element. Combinations of the two embodiments are also conceivable. For example, some of the optical waveguides can be provided in the structural element and others on the surface of the structural element.

The at least one optical waveguide typically runs from one end of the structural element to the opposite end of the structural element. The optical waveguides can be arranged next to one another at the same distances from one another. Alternatively, more optical waveguides can also be arranged in regions of the structural element that are possibly exposed to greater stress than in other regions. This also allows for a differentiated predication on the degree of damage to the structural component and increases the sensitivity of the sensor arrangement used.

Furthermore, optical waveguides can also run only partially in the structural element in portions. These optical waveguides then run along a surface, partly embedded in the structural element.

The structural element can be designed as a flat element. As such, it can represent part of the bodywork of a vehicle. In one embodiment, the structural component serves as underbody protection of a motor vehicle.

Furthermore, the structural component can be designed as a fiber-reinforced element. It can, for example, be a fiber-reinforced plastics material component made of fibers and thermoplastic or thermoset matrix material. In one embodiment, it is a fiber-reinforced plastics material component made of light-conducting fibers and thermoplastic or thermoset matrix material. The fibers or reinforcing fibers are then at least in part at the same time light-conducting fibers and serve as waveguides.

In addition, the structural element can comprise a woven fabric made of continuous fibers or a scrim made of continuous fibers. These continuous fibers can also serve at least partially as optical waveguides.

In addition, the structural element can comprises unidirectional profiles or tapes that are embedded in a thermoplastic or duromeric matrix.

In a further embodiment, the structural component comprises at least one photo- or light-emitting element and at least one photo- or light-sensitive element. The elements mentioned are thus components of the structural component. Typically, one light-emitting end is then assigned in each case to one end of the optical waveguide and one photosensitive element is assigned in each case to the other end of the optical waveguide. As elements, photoelectric semiconductor elements can in particular be taken into consideration. For example, the at least one light-emitting element can be a light-emitting diode (LED). The at least one light-sensitive element can be a photoresistor or a phototransistor.

Further advantages and embodiments of the invention emerge from the description and the accompanying drawing.

It goes without saying that the features mentioned above and those yet to be explained below can be used not only in the respectively specified combination, but also in other combinations or on their own, without departing from the scope of the present invention.

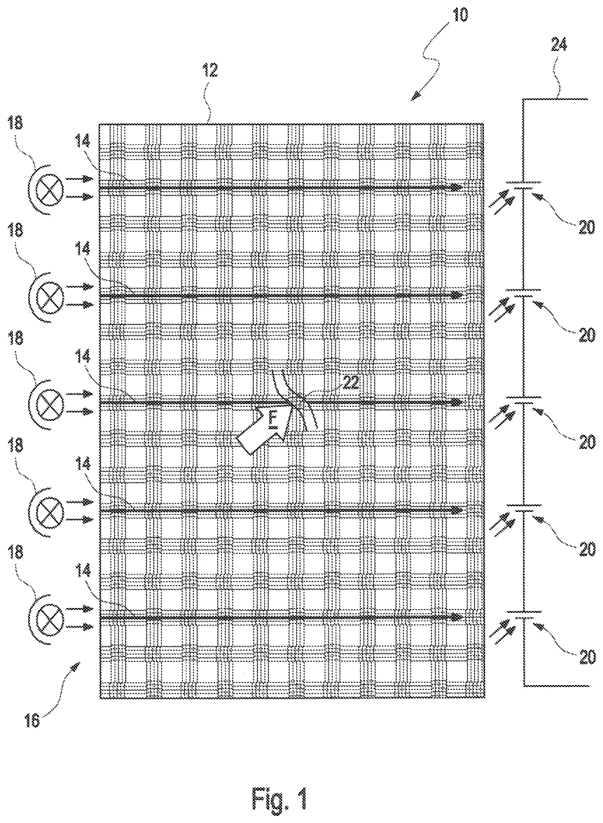

FIG. 1 shows an embodiment of the structural component presented in a schematic representation.

The invention is shown schematically in the drawing using an embodiment and is described in detail below with reference to the drawing.

FIG. 1 shows an embodiment of a structural component which is designated as a whole by the reference sign 10. This structural component 10 comprises a flat structural element 12, which in this case consists of a continuous fiber fabric, shown in this case without a surrounding thermoplastic or thermoset matrix. However, continuous fiber scrims are also conceivable.

Optical waveguides 14, for example glass fiber cables, run in the structural element 12, which represent a sensor arrangement 16 and extend over the entire surface of the structural element 12 to be monitored and thus the structural component 10. The existing glass fibers of the structural fabric can also serve as glass fiber cables.

On the left-hand side of the structural element 12, light is introduced into the optical waveguide 14 with light-emitting elements 18. In this case, LEDs are used as light-emitting elements 18, a light-emitting element 18 being assigned to each optical waveguide 14.

On the right-hand side of the structural element 12, photosensitive or light-sensitive elements 20, in this case photoresistors, are provided which capture or detect electromagnetic radiation transmitted through the optical waveguide 14, for example light. The optical waveguides 14 are attached in such a way that in the case of an overload of the structural component 10 by an externally acting force F, an impairment of the function or even a break 22 of at least one of the optical waveguides 14 takes place. The light conduction is thus interrupted and the photosensitive element 20 affected interrupts the flow of current in a series circuit 24 of the photosensitive elements 20.

In this way, it can be recognized whether one of the optical waveguides 18 is damaged. Depending on the evaluation of the detected light, the degree of damage to the optical waveguide(s) 14 and thus to the structural component 10 can also be determined. In particular, it can also be determined in which regions the structural component 10 is impaired or damaged. This increases the sensitivity of the sensor arrangement used.

The structural component 10 presented serves to protect components and parts and is attached, for example, to the underside of a motor vehicle. For this reason, the structural component 10 presented is designed as a flat, fiber-reinforced structural component 10.

1. Structural component, comprising a structural element and a sensor arrangement, wherein the sensor arrangement is connected to the structural element and comprises at least one optical waveguide.

2. Structural component according to claim 1, wherein the at least one optical waveguide is arranged in the structural element.

3. Structural component according to claim 1, wherein the at least one optical waveguide is arranged on a surface of the structural element.

4. Structural component according to claim 1, wherein the structural element is designed as a flat element.

5. Structural component claim 1, wherein the structural element is designed as a fiber-reinforced element having a thermoplastic or thermoset matrix.

6. Structural component according to claim 1, wherein the structural element comprises a woven fabric made of continuous fibers which is embedded in a thermoplastic or thermoset matrix.

7. Structural component according to claim 1, wherein the structural element comprises a scrim made of continuous fibers which is embedded in a thermoplastic or thermoset matrix.

8. Structural component according to claim 5, wherein fibers of the fiber-reinforced element serve at least partially as optical waveguides of the sensor arrangement.

9. Structural component according to claim 1, wherein the structural element comprises unidirectional profiles or tapes which are embedded in a thermoplastic matrix.

10. Structural component according to claim 1, wherein the structural element comprises unidirectional profiles or tapes which are embedded in a duromeric matrix.

11. Structural component according to claim 1, which has at least one light-emitting element and at least one photosensitive element.

12. Structural component according to claim 11, wherein the at least one light-emitting element is a light-emitting diode.

13. Structural component according to claim 11, wherein the at least one photosensitive element is a semiconductor photo-element.

14. Structural component according to claim 1, wherein the structural component is configured to serve as underbody protection of a motor vehicle.
